(19) United States
(12) Patent Application Publication
(10) Pub. No.: US 2023/0342444 A1
(43) Pub. Date: Oct. 26, 2023

(54) BIOMETRIC IMAGING ARRANGEMENT FOR INFRARED IMAGING COMPRISING MICROLENSES

(71) Applicant: Fingerprint Cards Anacatum IP AB, Göteborg (SE)

(72) Inventors: Johan HAMMERSBERG, FLODA (SE); Pontus JÄGEMALM, LERUM (SE)

(73) Assignee: Fingerprint Cards Anacatum IP AB, Göteborg (SE)

(21) Appl. No.: 18/028,892

(22) PCT Filed: Sep. 29, 2021
(86) PCT No.: PCT/SE2021/050959

§ 371 Date: Mar. 28, 2023

(30) Foreign Application Priority Data
Oct. 1, 2020 (SE) 2051142-4

(51) Int. Cl. G06F 21/32; G06V 40/12; H01L 27/146; G06V 40/13; G02B 5/30

(52) U.S. Cl. CPC G06F 21/32; G06V 40/1365; H01L 27/14627; H01L 27/14649; G06V 40/1318; G02B 5/30

(57) ABSTRACT

The present invention relates to a biometric imaging arrangement configured to be arranged under an at least partly transparent display panel and to acquire an infrared image of an object located on the opposite side of the least partly transparent display panel, the biometric imaging arrangement comprising: an image sensor comprising a detector pixel array configured to detect infrared light transmitted from the object for capturing an image, an at least partly transparent substrate comprising an array of microlenses, wherein each microlens is configured to redirect light through the least partly transparent substrate and onto the detector pixel array, wherein the at least partly transparent substrate further comprises optical decoupling areas configured to orthogonally redirect infrared light received from a side of the at least partly transparent substrate towards the object when being placed for imaging.

### FIELD OF THE INVENTION

The present invention relates to a biometric imaging arrangement and to an electronic device.

### BACKGROUND

Biometric systems are widely used as means for increasing the convenience and security of personal electronic devices, such as mobile phones etc. Fingerprint sensing systems, in particular, are now included in a large proportion of all newly released consumer electronic devices, such as mobile phones.

Optical fingerprint sensors have been known for some time and may be a feasible alternative to e.g. capacitive fingerprint sensors in certain applications. Optical fingerprint sensors may for example be based on the pinhole imaging principle and/or may employ micro-channels, i.e. collimators or microlenses to focus incoming light onto an image sensor.

It has recently been of interest to arrange optical fingerprint sensors under the display of electronic devices. For optical fingerprint sensor it is important to provide sufficient illumination to the finger when capturing an image of the finger located on the display.

To avoid adding further light sources to the already cramped space under the display, the light from the display itself may be used as a light source. However, this can in some situations be experienced as disturbing to a user, for example in a dark room where the light may be visible when it leaks out from the display.

Accordingly, there is a desire for biometric sensors that provides for less disturbing user interference and that can be assembled under the display of an electronic device.

### SUMMARY

In view of above-mentioned and other drawbacks of the prior art, it is an object of the present invention to provide an improved biometric imaging arrangement.

According to a first aspect of the invention, there is provided a biometric imaging arrangement configured to be arranged under an at least partly transparent display panel and to acquire an infrared image of an object located on the opposite side of the least partly transparent display panel, the biometric imaging arrangement comprising: an image sensor comprising a detector pixel array configured to detect infrared light transmitted from the object for capturing an image, and an at least partly transparent substrate comprising an array of microlenses, wherein each microlens is configured to redirect light through the least partly transparent substrate and onto the detector pixel array, wherein the at least partly transparent substrate further comprises optical decoupling areas configured to orthogonally redirect infrared light received from a side of the at least partly transparent substrate towards the object when being placed for imaging.

The present invention is based on the realization to use infrared light for illuminating the finger and to acquire infrared images of the object. This provides for illumination that is invisible to the human eye. Further, the inventors realized to use the at least partly transparent substrate on which the microlenses are arranged as a waveguide to guide infrared light received from the side of the at least transparent substrate to the object via decoupling areas. In this way, assembly of the biometric imaging arrangement can be made at reasonably low cost even in the cramped space often surrounding biometric sensors.

Further, the inventors realized to design the at least partly transparent substrate comprising the microlenses to orthogonally redirect infrared light. In other words, the infrared light that is used for illuminating the object can be injected from the side, and subsequently be orthogonally redirected towards the object by the same substrate that holds the microlenses without the need for additional components for guiding the light towards the object. This further provides for assembling the biometric imaging arrangement in a traditional way, for example in the often cramped space under the display of an electronic device.

The optical decoupling areas may be configured in various ways, but with the purpose of redirecting light received from the side of the least partly transparent substrate orthogonally away from the least partly transparent substrate towards the object for illumination of the object when the object is placed on the display panel for imaging. The substrate being adapted as a waveguide for the infrared light. The least partly transparent substrate is arranged to receive light at its sides and guide the light through optical coupling to the optical decoupling areas.

The least partly transparent substrate may guide the infrared light through total internal reflection. The optical decoupling areas may thus be configured to orthogonally decouple the infrared light out from the total internal reflection guiding.

Infrared light is herein understood to include light of wavelengths in the range covering “near infrared” to and including “far infrared” light. Infrared light is may thus be light of wavelengths of approximately 700 nanometers (approximately 430 THz) to approximately 50 micrometers (approximately 2 THz). Preferably, the infrared light used for embodiments herein is in the range of approximately 900 nanometers to approximately 1 micrometer, such as in the range of 930 nm to 960 nm. The infrared light may be approximately 940 nm.

The image sensor may be any suitable type of image sensor, such as a CMOS or CCD sensor connected to associated control circuitry. In one possible implementation the image sensor is a thin-film transistor (TFT) based image sensor which provides a cost-efficient solution for under display biometric imaging sensors. The operation and control of such image sensors for detecting infrared light can be assumed to be known and will not be discussed herein. The TFT image sensor may be a back illuminated TFT image sensor or a front illuminated TFT image sensor. The TFT image sensor may be arranged as a Hot-zone, Large Area or Full display solution.

The at least partly transparent substrate comprising the microlenses and the decoupling areas may be manufactured by means of e.g. lithography techniques or nano-imprint technology. and the deposition of the materials may be performed using e.g. thin film technology known per se.

The detector pixel array may be considered a photodetector pixel array.

In embodiments, the optical decoupling areas may be microlenses used both for redirecting light onto the detector pixel array and for orthogonally redirecting infrared light towards the object. Thus, the microlenses may advantageously be tailored to provide a dual function, to focus infrared light transmitted from the object onto the photodetector pixel array, and to orthogonally redirect infrared light received from a side of the at least partly transparent substrate towards the object to thereby illuminate the object. This provides for a very compact solution for a biometric infrared imaging arrangement that can be arranged under a display of an electronic device without or with reduced need for additional optical components in the optical stack.

In embodiments, the biometric imaging arrangement may comprise an optical polarizer arranged between the at least partly transparent substrate and the detector pixel array, the optical polarizer being configured to at least partly block light having the polarization of the light transmitted from the optical decoupling areas towards the object. In other words, light having the same polarization as the light transmitted from the optical decoupling areas towards the object is blocked by the optical polarizer. This advantageously provides for reducing the amount of infrared light that is decoupled from the decoupling areas directly towards the photodetector pixel array, and thereby increase the ratio of light transmitted from the object to reach the photodetector array. The optical polarizer is not transmissible to light having the polarization of the light transmitted from the decoupling areas towards the object.

Preferably, the optical polarizer may be configured to transmit light having polarization being orthogonal to the polarization of the light transmitted by the optical decoupling areas towards the object. In other words, the optical polarizer is advantageously transmissible to light of a polarization orthogonal to the light injected into the at least partly transparent substrate.

In embodiments, the optical polarizer may be a first optical polarizer, the biometric imaging arrangement may further comprise an optical circular polarizer arranged between the at least partly transparent substrate and the detector pixel array.

The optical circular polarizer may be arranged between the first optical polarizer and the at least partly transparent substrate comprising the microlenses.

The first optical polarizer may be a linear polarizer.

The transparent display panel may comprise a polarizer arrangement configured to receive light from the object and circularly polarize the light such that circular polarized light is transmitted towards the at least partly transparent substrate. This allows for turning the polarization of the light reflected by the object and transmitted towards the at least partly transparent substrate. The circular polarized light is at least partly allowed to pass through the optical polarizer arranged between the image sensor and the at least partly transparent substrate contrary to the light emitted by the light source and decoupled out from the at least partly transparent substrate.

Accordingly, embodiments of the present invention provide for efficient decoupling of infrared light towards the object and focusing of the light reflected from the object onto the photodetector pixel array, in a single layer, the single layer provided by the at least partly transparent substrate comprising the microlenses.

In embodiments, a grating pattern may be adapted to form the optical decoupling areas to redirect the infrared light through openings in the display panel and towards the object. Preferably, the decoupling areas of the least partly transparent substrate may be arranged to be aligned with openings in the display panel. The improves the ability to illuminate the object adequately for imaging.

A dimension of the grating pattern may be substantially the same as the wavelength of the infrared light. This provides for efficient decoupling of light towards the object.

A grating pattern may be any pattern that provides to a change in refraction index. Thus, it may be a change in material or a physical structure. Generally, a grating pattern is a structure that is able to redirect the infrared light by means of e.g. splitting and/or diffraction. A grating pattern may comprise of structures made in the material of the at least partly transparent substrate. The grating pattern may be periodic or may comprise aperiodic patterns.

The grating patterns are preferably formed in the at least partly transparent substrate and adjacent to the microlenses.

The biometric imaging arrangement may comprise an infrared light source for producing the infrared light. The infrared light being input in parallel with a main plane of the at least partly transparent substrate. Such a light source is preferably arranged at the outer perimeter or edge of the image sensor or the display panel. Thus, the light source is arranged so that it does not cover the image sensor pixels. A waveguide may be arranged to guide the light from the light source to the least partly transparent substrate on the image sensor.

The infrared light source may be arranged adjacent to least partly transparent substrate.

According to a second aspect of the present invention there is provided an electronic device comprising: an at least partly transparent display panel; the biometric imaging arrangement according to embodiments of the present invention, and processing circuitry configured to: receive a signal from the biometric imaging arrangement indicative of a biometric object touching the transparent display panel, perform a biometric authentication procedure based on the detected fingerprint.

The electronic device may be e.g. a mobile device such as a mobile phone (e.g. Smart Phone), a tablet, a phablet, etc.

Further effects and features of the second aspect of the invention are largely analogous to those described above in connection with the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates an example of an electronic device according to embodiments of the invention;

FIG. 2 is a schematic box diagram of an electronic device according to embodiments of the invention;

FIG. 3 schematically illustrates a biometric imaging arrangement according to embodiments of the invention;

FIG. 4 schematically illustrates a biometric imaging arrangement comprising a polarizer according to embodiments of the invention;

FIG. 5A schematically illustrates a biometric imaging arrangement comprising a polarizer according to embodiments of the invention;

FIG. 5B schematically illustrates a biometric imaging arrangement comprising a polarizer according to embodiments of the invention;

FIG. 6 conceptually illustrates an at least partly transparent substrate comprising microlenses and grating patterns according to embodiments of the invention;

FIG. 7 schematically illustrates a biometric imaging arrangement according to embodiments of the invention;

FIG. 8A conceptually illustrates an example decoupling area in the form of grating patterns formed in a substrate according to embodiments of the invention;

FIG. 8B conceptually illustrates an example decoupling area in the form of grating patterns formed in a substrate according to embodiments of the invention;

FIG. 8C conceptually illustrates an example decoupling area in the form of grating patterns formed in a substrate according to embodiments of the invention;

FIG. 8D conceptually illustrates an example decoupling area in the form of grating patterns formed in a substrate according to embodiments of the invention;

FIG. 8E conceptually illustrates an example decoupling area in the form of grating patterns formed in a substrate according to embodiments of the invention; and

FIG. 9 conceptually illustrating an at least partly transparent substrate in the form of a polymer film comprising microlenses according to embodiments of the invention.

### DETAILED DESCRIPTION OF EXAMPLE EMBODIMENTS

In the present detailed description, various embodiments of the biometric imaging arrangement according to the present invention are mainly described with reference to a biometric imaging arrangement arranged under a display panel. However, it should be noted that the described imaging device also may be used in other biometric imaging applications such as in an optical fingerprint sensor located under a cover glass or the like.

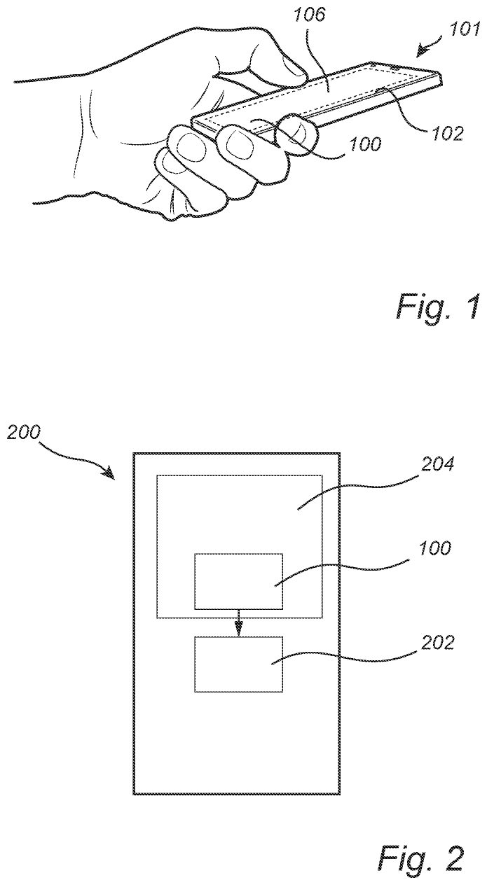

Turning now to the drawings and in particular to FIG. 1, there is schematically illustrated an example of an electronic device configured to apply the concept according to the present disclosure, in the form of a mobile device 101 with an integrated in-display optical biometric imaging arrangement 100 and a display panel 102 with a touch screen interface 106. The optical biometric imaging arrangement 100 may, for example, be used for unlocking the mobile device 101 and/or for authorizing transactions carried out using the mobile device 101, etc.

The optical biometric imaging arrangement 100 is here shown to be smaller than the display panel 102, but still relatively large, e.g. a large area implementation. In another advantageous implementation the optical biometric imaging arrangement 100 may be the same size as the display panel 102, i.e. a full display solution. Thus, in such case the user may place his/her finger anywhere on the display panel for biometric authentication. The optical biometric imaging arrangement 100 may in other possible implementations be smaller than the depicted optical biometric imaging arrangement, such as providing a hot-zone implementation.

Preferably and as is apparent for the skilled person, the mobile device 101 shown in FIG. 1 may further comprise a first antenna for WLAN/Wi-Fi communication, a second antenna for telecommunication communication, a microphone, a speaker, and a phone control unit. Further hardware elements are of course possibly comprised with the mobile device.

It should furthermore be noted that the invention may be applicable in relation to any other type of electronic devices comprising transparent display panels, such as a laptop, a tablet computer, etc.

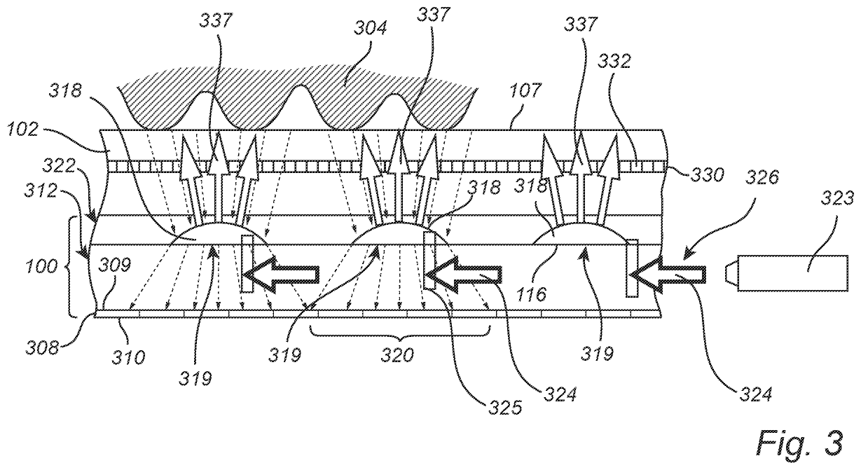

FIG. 2 is a schematic box diagram of an electronic device according to embodiments of the invention. The electronic device 200 comprises a transparent display panel 204 and an optical biometric imaging arrangement 100 conceptually illustrated to be arranged under the transparent display panel 204 according to embodiments of the invention. Furthermore, the electronic device 200 comprises processing circuitry such as control unit 202. The control unit 202 may be stand-alone control unit of the electronic device 202, e.g. a device controller. Alternatively, the control unit 202 may be comprised in the optical biometric imaging arrangement 100.

The control unit 202 is configured to receive a signal indicative of a detected object from the optical biometric imaging arrangement 100. The received signal may comprise image data.

Based on the received signal the control unit 202 is arranged to detect a fingerprint. Based on the detected fingerprint the control unit 202 is configured to perform a fingerprint authentication procedure. Such fingerprint authentication procedures are considered per se known to the skilled person and will not be described further herein.

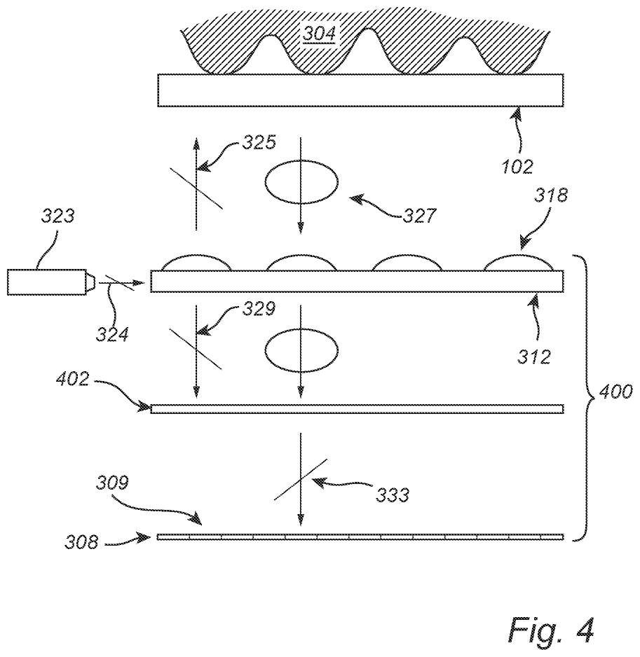

FIG. 3 schematically illustrates a biometric imaging arrangement 100 according to embodiments of the invention. The biometric imaging arrangement 100 is arranged under an at least partly transparent display panel 102 and to acquire an infrared image of an object 304 located on the opposite side of the least partly transparent display panel 102.

It should be understood that the biometric imaging arrangement 100 may be arranged under any cover structure which is sufficiently transparent, as long as the image sensor receives a sufficient amount of light to capture an image of a biometric object in contact with the outer surface of the cover structure, such as a fingerprint or a palmprint. However, in the following, a biometric imaging arrangement 100 configured to capture an image of a finger 304 in contact with an outer surface 107 of the display panel 102 is described.

The biometric imaging arrangement comprises an image sensor 308 comprising a detector pixel array 309 configured to detect infrared light transmitted from the object 304 for capturing an image.

Each pixel 310 is an individually controllable photodetector arranged to detect an amount of incoming light and to generate an electric signal indicative of the light received by the detector. The image sensor 308 may be any suitable type of image sensor, such as a CMOS or CCD sensor connected to associated control circuitry. However, the image sensor 308 may in some implementations be a thin-film transistor (TFT) based image sensor which provides a cost-efficient solution. The operation and control of such an image sensor can be assumed to be known and will not be discussed herein.

The biometric imaging arrangement further comprises an at least partly transparent substrate 312 comprising an array of microlenses 318. The at least partly transparent substrate 312 is arranged to cover the image sensor 308. Each microlens 318 is configured to redirect light through the least partly transparent substrate 312 and onto the detector pixel array 309, preferably onto a respective subarray 320 of pixels.

The at least partly transparent substrate 312 is attached to the display panel 102 using a suitable adhesive 322 that preferably has a lower refractive index than the refractive index of the at least partly transparent substrate 312 and the microlenses 318.

The at least partly transparent substrate 312 further comprises optical decoupling areas 319 configured to orthogonally redirect infrared light 324 received from a side 326 of the at least partly transparent substrate towards the object when being placed for imaging.

An infrared light source 323 is arranged adjacent to the at least partly transparent substrate 312 and the image sensor 309 to emit infrared light 324 into the at least partly transparent substrate 312 from the side 326, e.g. at the edge 326 of the at least partly transparent substrate 312. The infrared light 324 being input in parallel with a main plane of the at least partly transparent substrate. The main plane is parallel with the display panel 102 and/or the pixel array 309.

The infrared light 324 is guided by the at least partly transparent substrate 312 acting like a waveguide. When the infrared light 324 reaches a decoupling area 319 the light is orthogonally decoupled out from the at least partly transparent substrate 312 towards the object 304, see conceptual light beams 337 orthogonally decoupled from the substrate 312. Preferably, and as conceptually illustrated in FIG. 3, the optical decoupling areas 319 are microlenses 318 used both for redirecting light onto the detector pixel array reflected by the object and for vertically redirecting infrared light 324 towards the object 304. This may be achieved by designing the microlenses to both focus light onto the pixels and to decouple the infrared light 324 travelling in the substrate 312 acting waveguide. Further, this may also be achieved by appropriate material selection for the microlenses and the substrate 312.

Orthogonally is here with regards to the main plane of the waveguide as provided by the at least transparent substrate in which the light is guided. Some spread of the light when it is decoupled out from the substrate towards the object is conceivable. This spread will provide some light that is decoupled at an angle that deviates from 90 degrees with respect to the plane of the substrate. Thus, a deviation from orthogonal, i.e. 90 degrees is allowed. However, at least a portion of the decoupled light is transmitted orthogonally from the plane of the substrate 312 in which the light 324 is being guided. A main portion of the decoupled light is redirected towards the object. In other words, the decoupling areas are adapted to redirect at least a portion of the light guided by the waveguide towards the location where an object is intended to be located for imaging. It may be considered that the optical axis of the redirected light is orthogonal to the main plane of the waveguide structure.

Generally, light may travel in a waveguide through total internal reflection. As long as the incidence angle of the light inside the waveguide is less that a critical angle Δ=arcsine(n2/n1) based on the refractive indices of the waveguide (n1) and the surrounding medium (n2), the light will be reflected without loss inside the waveguide. However, with the above described microlenses, the angle of incidence will be altered at the location of the microlenses, thereby leading to a lossy reflection and decoupling of light out from the microlens towards the object 304. For this to occur efficiently, the mode of the light 324 at least partly penetrates the microlens, as conceptually illustrated by box 325 indicating a conceptual mode 325 penetrating into the microlens 318.

It should further be noted that components of the drawings such as the microlenses 318 and display pixels are not drawn to scale. The microlens 318 is shown to receive light reflected by the object 304 which has propagated through the display panel 102 before reaching the microlens 318 and the light received by the microlens 318 is focused onto the image sensor 308.

The display panel 102 comprises a display 330 comprising individually controllable light emitting units, e.g. pixels, of which one is denoted 332. The pixels may provide e.g. red, green, and blue light. Various types of displays can be used in accordance with embodiments. For example, displays based on OLED, u-LED with any type of tri-stimulus emission like RGB, CMY or others.

There are suitable openings or optical paths past the color controllable light source 330 so that the light beams being transmitted from the object 304 can reach the image sensor 308. For example, the color controllable light source may be a display with the light sources not being completely dense. In other words, this allows the reflected light from the display and the object to reach the sensor.

The decoupling areas 319 may be arranged to redirect the infrared light 324 through openings in the display 330 and towards the object 304.

The decoupling areas 319 may be arranged to be aligned with the openings in the display 330.

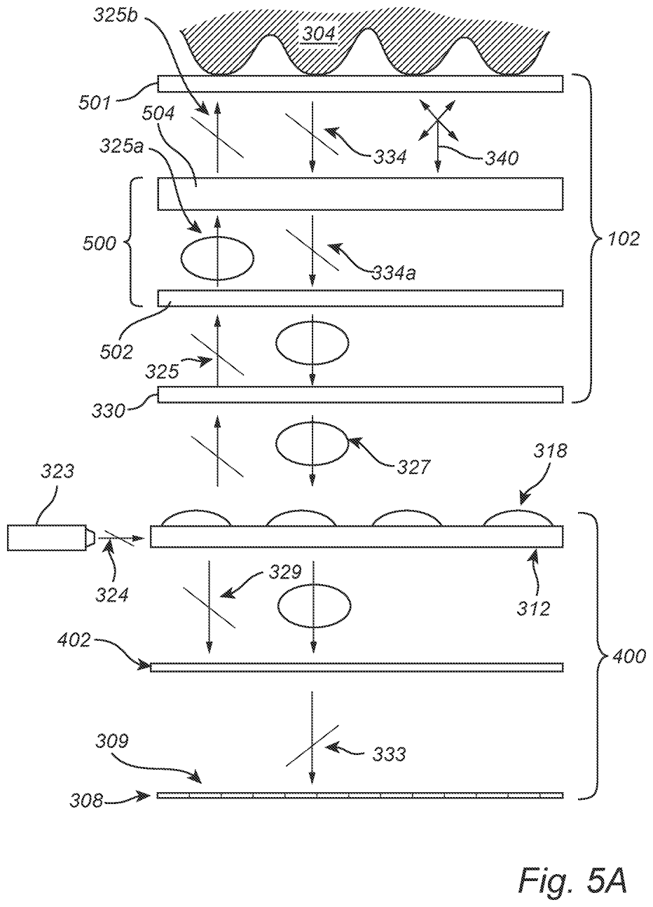

FIG. 4 schematically illustrates a biometric imaging arrangement 400 according to embodiments of the invention. The biometric imaging arrangement 400 comprises the at least partly transparent substrate 312 with the microlenses 318, and the image sensor 308 comprising the detector pixel array 309 as described with reference to FIG. 3.

In addition, the biometric imaging arrangement 400 comprises an optical polarizer 402 arranged between the at least partly transparent substrate 312 and the detector pixel array 309. The optical polarizer 402 being configured to block light having the same polarization as the light 325 transmitted from the optical decoupling areas 319 towards the object 304.

As described above, the infrared light source 323 is arranged to emit infrared light 324 into the substrate 312 acting as a waveguide. The light 324 has a transverse electric mode, i.e. it is linearly polarized along a direction transverse to the direction of propagation. Decoupling areas of the substrate 312, provided by the microlenses 318 or by grating patterns on the substrate, redirect light towards the object 304 located on the opposite side of the display panel 102.

A portion 329 of the light 324 is redirected from the substrate 312 towards the image sensor 308. However, the polarizer 402 is designed to block light having the polarization of the infrared light 324 emitted by the light source 323. For example, the polarizer 402 may be transmissive to transmit light having polarization being orthogonal to the polarization of the light 325 transmitted by the optical decoupling areas towards the object 304. The stray light 329 has the same polarization as the light 325 and is thus blocked by the polarizer 402. Thus, the polarizer advantageously reduces or even eliminates stray light from the light source and substrate 312 to be directly transmitted to the image sensor without having been reflected by the object 304. The advantageously provides improve image contrast.

The at least partly transparent display panel 102 here comprises a polarizer arrangement configured to receive light from the object 304 and circularly polarize the light such that circular polarized light 327 is transmitted towards the at least partly transparent substrate 312. Thus, light that has passed through the at least partly transparent display panel 102 is circularly polarized when it reaches the at least partly transparent substrate 312. This advantageously provides for the linear polarizer 402 to allow one linear polarization of the reflected light 327 to pass through the polarizer 402 and reach the image sensor 308, while at the same time block the stray light 329. It may also be conceivable that the light transmitted from the display panel is linearly polarized and comprises specular and diffuse components depending on the specific configuration of the display panel 102.

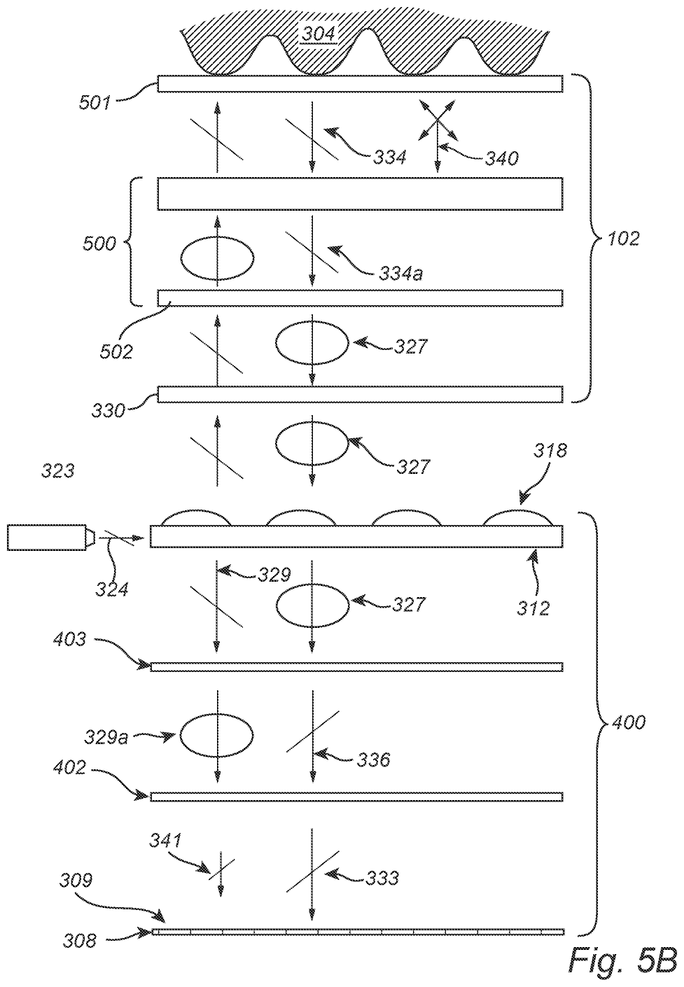

FIG. 5A conceptually illustrates the biometric imaging arrangement 400 and a possible polarizer arrangement 500 that may provide circular polarized light based on the light from the object 304. The display panel 102 comprises the display 330, such as an OLED display, a λ/4 polarizer 502 and a linear polarizer 504. The λ/4 polarizer 502 and the linear polarizer 504 are arranged in parallel in a stacking direction of the display panel 102. Briefly, light 325 transmitted towards the object 304 and that the passes through the λ/4 polarizer 502 becomes circularly polarized 325a and subsequently linearly polarized 325b by the linearly polarizer 504 before being reflected by the object 304.

Light 334 returning from the object 304 located opposite the cover glass 501 is linearly polarized 334a by the linearly polarizer 504 and subsequently circularly polarized by the λ/4 polarizer 502 to provide the circular polarized light 327 that is transmitted towards the substrate 312 and the linear polarizer 402. Displays comprising λ/4 polarizer 502 and a linear polarizer 504 are known per se to the skilled person. Embodiments of the present invention takes advantage of the polarization effect provided by such displays 102 in order to efficiently provide, at the same time, efficient decoupling of light from the substrate and thereby illumination of the object and focusing of the reflected light onto the detector pixel array 309.

The light discussed here and indicated in the drawings are primarily specular light. However, there is further naturally diffused light in the optical stack. For example, after reflection by the object, a diffuse light component 340 is also produced. The diffuse light component 340 is unpolarized and is at least partly filtered away by the polarizers of the polarizer arrangement 500 in the display panel 102. However, a part of the diffuse light 340 reaches the optical sensor 302 and has the same polarization as the light 333 having passed through the linear polarizer 402, and that finally reaches the image sensor 308.

FIG. 5A conceptually illustrates a biometric image arrangement comprising a stack of an image sensor 308, a linear polarizer 402, and the at least partly transparent substrate 312 acting as a waveguide and comprising the microlenses 318.

FIG. 5B conceptually illustrates the biometric imaging arrangement 400 comprising an optical circular polarizer 403 arranged between the at least partly transparent substrate 312 acting as a waveguide and the detector pixel array 309. Further, the linear polarizer 402, is arranged between the optical circular polarizer 403 and the detector pixel array 309. The optical circular polarizer 403 is arranged between the linear polarizer 402 and the at least partly transparent substrate 312. In this way, light 327 returning from the object 304, and polarized by the polarizer arrangement 500, is received by the circular polarizer 403, i.e. a λ/4 plate, whereby linear polarized light 336 is transmitted towards the linear polarizer 402. The advantage of including the λ/4 plate 403 between the linear polarizer 402 and the at least partly transparent substrate 312 is that the intensity of the light 333 that reaches the image sensor 308 is less suppressed compared to only having the linear polarizer 402 (see e.g. FIG. 4 or FIG. 5A), however at the cost of a small component of stray light 341.

FIG. 5B conceptually illustrates a biometric image arrangement comprising a stack of an image sensor 308, a linear polarizer 402, a circular polarizer 403 and the at least partly transparent substrate 312 acting as a waveguide and comprising the microlenses 318.

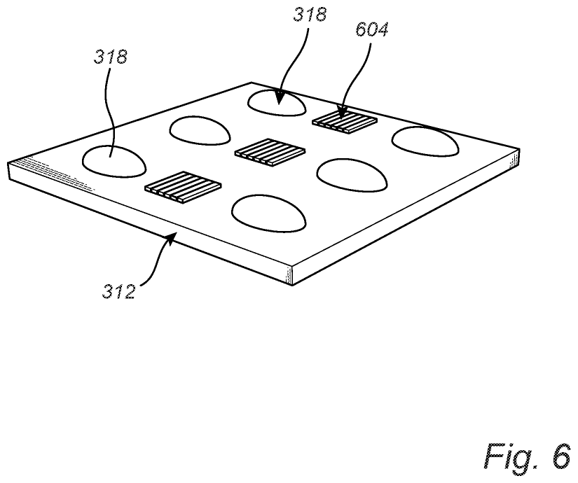

FIG. 6 conceptually illustrates an at least partly transparent substrate 312 comprising microlenses 318 and further comprising decoupling areas comprising grating pattern 604 formed in the at least partly transparent substrate 312. Here the grating pattern 604 is arranged next to or adjacent to at least one microlenses 318. Further, the decoupling areas comprising the grating pattern 604 is in the same main plane as the microlenses 318, the plane being the plane of the least partly transparent substrate 312.

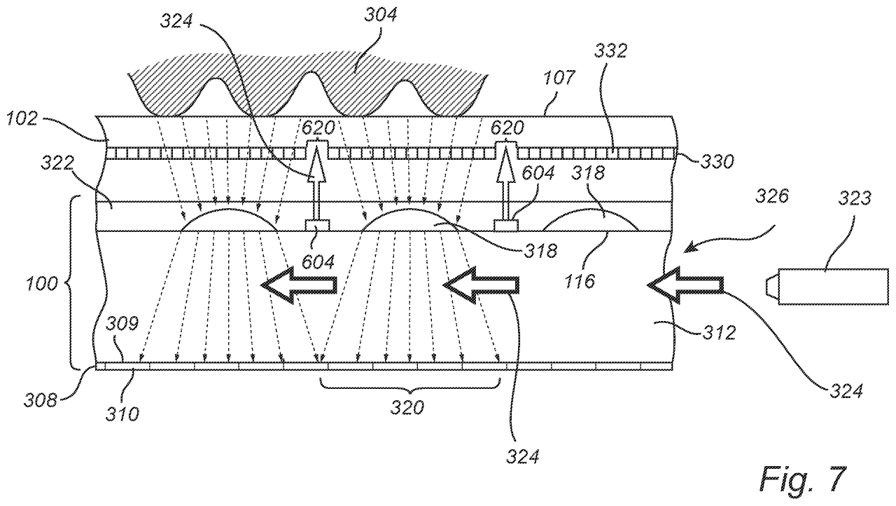

Turning to FIG. 7, the grating patterns 604 are adapted to form the optical decoupling areas to redirect the infrared light through openings 620 in the display panel and towards the object. The grating patterns 604 may be aligned with the openings 620 in the display 330.

A dimension of the grating pattern is substantially the same as the wavelength of the infrared light. This provides for efficient decoupling of light out from the waveguide structure. A dimension of the grating pattern may relate to the linewidth of the structures of the grating pattern.

Grating patterns may be provided in various forms of which a few examples will now be described.

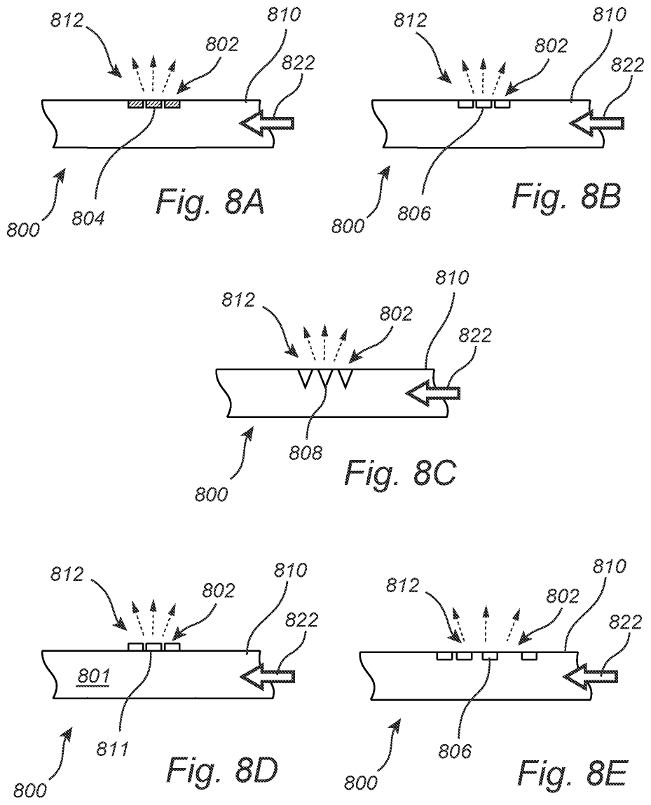

As conceptually illustrated in FIG. 8A, the decoupling area 812 may comprise a grating pattern 802 formed in the substrate structure 800 by means of a different material. Structures 804 are formed on the waveguide structure 800, for example by means of providing a material having suitable optical properties in cavities or trenches formed in the waveguide material. Thus, the substrate material is made from a first material and the grating pattern 802 comprises a second material that is not the same as the first material. By selecting the second material according to suitable refraction index, it is possible to achieve the orthogonal redirection of an incoming light beam 822. The material of the grating should be transparent to light of the wavelength of the infrared light emitted by the light source. This provides for the wave front of the emitted infrared light to at least partly travel in the microlenses and gratings to thereby enable decoupling of the light.

In FIGS. 8B-C the decoupling areas 812 comprises grating patterns 802 that are provided by means of trenches 806, 808 made in the waveguide structure upper surface 810. As conceptually illustrated, the trenches can be different cross-sectional shapes. For example, a rectangular like cross-section as the trenches 806 in FIG. 8B or a triangular like cross-section as the trenches 808 in FIG. 4C. The preferred embodiment is that the substrate 800, the gratings and the microlenses are made in the same material.

FIG. 8D conceptually illustrates another conceivable decoupling area 812 provided by means of a grating pattern 802. Here, the grating pattern comprises protruding structures 811 protruding out from the upper surface 810 of the waveguide structure 800. The protruding structures 811 may be made in the same material as the body 801 of the waveguide structure 800, or the protruding structures 811 may comprise a second material different from the material of the material of the body of the waveguide structure 800.

The grating patterns 802 may be periodic, thus formed in a periodic pattern with the equidistant distribution between trenches and/or cavities. conceptually illustrated in FIGS. 8A-D are periodic.

However, in other possible implementations, the grating patterns may be aperiodic, as is conceptually illustrated in FIG. 8E where the grating structures 806 are not equidistant distributed, i.e. the distance between grating structures 806 such as trenches are varying across the grating pattern 802.

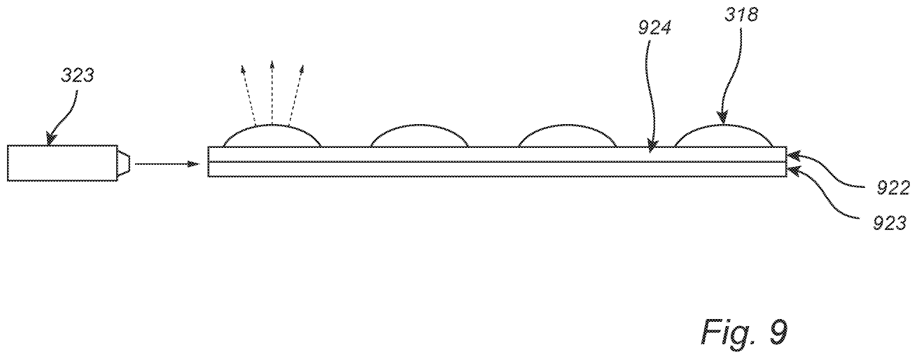

The at least partly transparent substrate may be part of a film on which the microlenses are formed. Turning to FIG. 9 conceptually illustrating an at least partly transparent substrate in the form of a polymer film 922 comprising microlenses 318. The polymer film 922 is arranged on a second at least partly transparent substrate 932 for subsequent arrangement in a biometric imaging arrangement. The polymer film 922 is configured as a horizontal waveguide and the microlenses are configured to focus light onto an image sensor and to orthogonally redirect light guided in the polymer film 922 towards an object as described above.

The fabrication of the waveguide film 922 in suitable polymer with decoupling areas either realized by the microlenses or by separate grating patterns can be made with nano-in-print technology, even in roll-to-roll volume manufacturing. Nano-imprint technology is considered known to the skilled person. The thickness of the film core 924 is preferably about 5-50 micrometer, for example approximately 10 micrometers.

Regardless of whether or not the same type of structures, i.e. the microlenses, are configured for the redirection of light from the waveguide as for focusing light reflected from the finger on the image sensor for imaging, embodiments disclosed herein provides for the possibility to manufacture the needed structures on the same film 922, thereby lowering the system cost.

Preferably, the refractive index of the lenses 318, the waveguide structure, for example as provided by the film core 924, or by another substrate, e.g. substrate 922, and the refractive index of any adhesives used in the stack are relatively well matched to ensure that the mode of the input light provided by the light source 923 vertically cover the lenses 318.

The microlenses are herein illustrated as plano-convex lenses having the flat surface orientated towards the transparent substrate. It is also possible to use other lens configurations and shapes. A plano-convex lens may for example be arranged with the flat surface towards the display panel, even though the imaging performance may be degraded compared to the reverse orientation of the microlens. It is also possible to use other types of lenses such as convex lenses. An advantage of using a plano-convex lens is the ease of manufacturing and assembly provided by a lens having a flat surface.

A control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device. It should be understood that all or some parts of the functionality provided by means of the control unit (or generally discussed as “processing circuitry”) may be at least partly integrated with the biometric imaging arrangement.

Even though the invention has been described with reference to specific exemplifying embodiments thereof, many different alterations, modifications and the like will become apparent for those skilled in the art. Also, it should be noted that parts of the imaging device may be omitted, interchanged or arranged in various ways, the imaging device yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A biometric imaging arrangement configured to be arranged under an at least partly transparent display panel and to acquire an infrared image of an object located on the opposite side of the least partly transparent display panel, the biometric imaging arrangement comprising:
an image sensor comprising a detector pixel array configured to detect infrared light transmitted from the object for capturing an image,
an at least partly transparent substrate comprising an array of microlenses, wherein each microlens is configured to redirect light through the least partly transparent substrate and onto the detector pixel array for imaging,
wherein the at least partly transparent substrate further comprises optical decoupling areas configured to orthogonally redirect infrared light received from a side of the at least partly transparent substrate towards the object when being placed for imaging,
wherein the optical decoupling areas are microlenses used both for redirecting light onto the detector pixel array and for vertically redirecting infrared light towards the object.

2. The biometric imaging arrangement according to claim 1, comprising an optical polarizer arranged between the at least partly transparent substrate and the detector pixel array, the optical polarizer being configured to block light having the polarization of the light transmitted from the optical decoupling areas towards the object.

3. The biometric imaging arrangement according to claim 2, wherein the optical polarizer is configured to transmit light having polarization being orthogonal to the polarization of the light transmitted by the optical decoupling areas towards the object.

4. The biometric imaging arrangement according to claim 2, wherein the optical polarizer is a first polarizer, the biometric imaging arrangement further comprising an optical circular polarizer arranged between the at least partly transparent substrate and the detector pixel array.

5. The biometric imaging arrangement according to claim 3, wherein the optical polarizer is a first polarizer, the biometric imaging arrangement further comprising an optical circular polarizer arranged between the at least partly transparent substrate and the detector pixel array, wherein the optical circular polarizer is arranged between the first optical polarizer and the at least partly transparent substrate.

6. The biometric imaging arrangement according to claim 3, wherein the first optical polarizer is a linear polarizer.

7. The biometric imaging arrangement according to claim 1, wherein the at least partly transparent display panel comprises a polarizer arrangement configured to receive light from the object and circularly polarize the light such that circular polarized light is transmitted towards the at least partly transparent substrate.

8. The biometric imaging arrangement according to claim 1, wherein a grating pattern is adapted to form the optical decoupling areas to redirect the infrared light through openings in the display panel and towards the object.

9. The biometric imaging arrangement according to claim 8, wherein the optical decoupling areas comprises grating patterns formed adjacent to the microlenses.

10. The biometric imaging arrangement according to claim 8, wherein the decoupling areas of the least partly transparent substrate are arranged to be aligned with openings in the display panel.

11. The biometric imaging arrangement according to claim 8, wherein a dimension of the grating pattern is substantially the same as the wavelength of the infrared light.

12. The biometric imaging arrangement according to claim 1, comprising an infrared light source for producing the infrared light being input in parallel with a main plane of the at least partly transparent substrate.

13. The biometric imaging arrangement according to claim 12, wherein the infrared light source is arranged adjacent to the least partly transparent substrate.

14. An electronic device comprising:
an at least partly transparent display panel;
the biometric imaging arrangement according to claim 1, and
processing circuitry configured to:
receive a signal from the biometric imaging arrangement indicative of a biometric object touching the transparent display panel,
perform a biometric authentication procedure based on the detected fingerprint.

15. The electronic device according to claim 14, wherein the electronic device is a mobile device.

16. A biometric imaging arrangement configured to be arranged under an at least partly transparent display panel and to acquire an infrared image of an object located on the opposite side of the least partly transparent display panel, the biometric imaging arrangement comprising:
an image sensor comprising a detector pixel array configured to detect infrared light transmitted from the object for capturing an image,
an at least partly transparent substrate comprising an array of microlenses, wherein each microlens is configured to redirect light through the least partly transparent substrate and onto the detector pixel array for imaging,
wherein the at least partly transparent substrate further comprises optical decoupling areas configured to orthogonally redirect infrared light received from a side of the at least partly transparent substrate towards the object when being placed for imaging,
wherein the optical decoupling areas are arranged adjacent to and in the same plane as the microlenses.

17. The biometric imaging arrangement according to claim 16, comprising an optical polarizer arranged between the at least partly transparent substrate and the detector pixel array, the optical polarizer being configured to block light having the polarization of the light transmitted from the optical decoupling areas towards the object.

18. The biometric imaging arrangement according to claim 17, wherein the optical polarizer is configured to transmit light having polarization being orthogonal to the polarization of the light transmitted by the optical decoupling areas towards the object.

19. The biometric imaging arrangement according to claim 16, wherein the optical decoupling areas comprises grating patterns.

20. The biometric imaging arrangement according to claim 16, wherein the decoupling areas of the least partly transparent substrate are arranged to be aligned with openings in the display panel.
